(19) United States
(12) Patent Application Publication
(10) Pub. No.: US 2010/0067387 A1
(43) Pub. Date: Mar. 18, 2010

(54) Network Capture Method Using a Transformer

(76) Inventor: Shuji Tsunoda, Tokyo (JP)

Correspondence Address: MEYERTONS, HOOD, KIVLIN, KOWERT & GOETZEL, P.C., P.O. BOX 398, AUSTIN, TX, 78767-0398, US

(21) Appl. No.: 12/209,304

(22) Filed: Sep. 12, 2008

(51) Int. Cl. G06F 11/30

(52) U.S. Cl. 370/252

(57) ABSTRACT

A non-intrusive method to monitor a digital network, the method comprising using a non-intrusive element, connecting to one or more differential lines carrying digital communication on a digital network without physically altering the one or more differential lines or introducing another network device. The method further comprises monitoring the digital communication using the non-intrusive element, capturing a portion of the digital communication using the non-intrusive element, and sending the captured portion of the digital communication to a network analyzer to analyze the captured portion.

### FIELD OF THE INVENTION

The present invention relates to the field of coupling to a digital network for the purposes of monitoring and/or analyzing digital communication on the digital network.

### DESCRIPTION OF THE RELATED ART

Media Oriented Systems Transport (MOST) is a computer networking standard intended for interconnecting multimedia components (in-vehicle consumer devices such as DVD players, MP3 players, GPS systems, car phones and Bluetooth devices, among others) in automobiles and other vehicles (see FIG. 1A). It differs from existing vehicle bus technologies in that it is intended to be carried largely on an optical fiber, thus providing a bus-based networking system at bit-rates higher than available on previous vehicle-bus technologies. However, digital communication on the MOST network may also use differential lines. Specifically, the physical layer of the MOST network defines mediums such as fiber optics and unshielded twisted pair cables (UTP). The MOST network supports various speed grades, including 25 Mbit/s, 50 Mbit/s, and 150 Mbit/s, with higher network speeds possible.

MOST technology enables network devices operate together as a single system rather than independent devices each requiring their own control. The MOST network specification defines the protocol, hardware, and software layers for transport of various types of MOST packets (i.e., control, real-time, and packet data) over a physical medium. The MOST specification defines all seven layers of the International Organization for Standardization (ISO)/Open Systems Interconnection (OSI) Reference Model for data communication (see FIG. 1B). The MOST network often employs a ring topology, but star configurations and double rings for critical applications are possible and may include up to 64 devices or nodes (see FIG. 1C). MOST network devices may also have the plug and play capability for easy addition/removal to/from the MOST network.

MOST development is done by the MOST COOPERATION, an industry-standards body consisting of automotive manufacturers (including FORD, BMW, MERCEDES, and GENERAL MOTORS), and various automotive electrical suppliers and audio-video manufacturers.

MOST is a synchronous digital network that includes various types of network devices. For example, a timing master can supply a clock (e.g., using a synchronous and continuous data signal) and all other MOST network devices can synchronize their operation to this signal. This technology eliminates the need for buffering and sample rate conversion, so that simple and inexpensive devices can be used. Furthermore, packet header of MOST network packets can synchronize the rest of the MOST network devices (e.g., timing slaves).

The MOST network uses a synchronous base data signal that facilitates digital communication, including transport of multiple streaming data channels and a control channel. The control channel is used to set up streaming data channels for use by the sender and receiver. Once the connection is established, data can flow continuously, and no further addressing or processing of packet label information may be needed. The bandwidth of the streaming data channels may be reserved for a dedicated stream, thus possibly eliminating any interruptions, collisions, or slow-downs in the transport of the data stream. This may be the optimum mechanism for delivering streaming data (i.e., information that flows continuously) like audio and video.

Computer based data, such as Internet traffic or information from a navigation system, may be sent in short (asynchronous) bursts as packets and is often going to many different places. To accommodate such signals, the MOST network specification defines efficient mechanisms for sending asynchronous, packet based data in addition to the control channel and streaming data channels (see FIG. 1D). These mechanisms may run on top of the permanent synchronous data signal. However, they may be separate from the control channel and the streaming data channels, such that there is no interference with each other.

There are various tools that can be used to monitor digital communication on a MOST network 200, or any digital network. However, as can be seen in FIGS. 2A and 2B, a connection of a typical network analyzer 208 usually results in creating an additional node on the digital network. For example, as FIG. 2B illustrates, the addition of the network analyzer device may add an additional network device to the network (which originally consists of nodes 202A-C), thus creating an artificial network. The insertion of a network analyzer 208 into the digital network can also create communication delays and timing issues.

### SUMMARY OF THE INVENTION

Various embodiments of a non-intrusive network probe and analyzer are presented below. In some embodiments, the network probe may use a ferrite bead, or other type of a transformer, that can surround one or more communication lines (e.g., differential lines such as UTP) that carry digital communication on a digital network. Thus the network probe may couple to the digital network unobtrusively, meaning that it may not create another device on the digital network, and/or it may not cause delays and/or timing issues.

The network probe can be added to the digital network without affecting the digital network or physically altering the one or more communication lines (i.e., not using a physical harness to couple to the network, or cutting any of the actual wires). Although built-in connections (e.g., using physical harnesses) to the digital network may exist in a laboratory, they are usually not manufactured in the final product due to cost, space, and/or performance reasons.

As a result, the user can interface with the digital network outside of a lab without having to cut into the communication lines or having to build and/or use a harness. Additionally, the user can interface with the digital network without altering the topology of the network, thus eliminating any negative timing and/or performance issues that may be associated with adding an extra device (e.g., a network analyzer) to the digital network.

### BRIEF DESCRIPTION OF THE DRAWINGS

A better understanding of the present invention can be obtained when the following detailed description of the preferred embodiment is considered in conjunction with the following drawings, in which:

FIG. 1A is a block diagram of an exemplary MOST network, according to some embodiments;

FIG. 1B is a block diagram of the OSI Interconnect Reference Model, according to some embodiments;

FIG. 1C is an illustration of exemplary digital network topologies, according to some embodiments;

FIG. 1D is a block diagram of an exemplary data frame, according to some embodiments;

FIGS. 2A and 2B illustrate connecting to a digital network using an intrusive element, according to some embodiments;

FIG. 3A is a block diagram of an exemplary two device digital network, according to some embodiments;

FIG. 3B is a block diagram of an exemplary non-intrusive element coupled to an exemplary digital network, according to some embodiments;

FIG. 4 is a block diagram of an exemplary non-intrusive element, according to some embodiments;

FIG. 5 is a block diagram of an exemplary non-intrusive element connected to an exemplary digital network, according to some embodiments;

FIG. 6A is a block diagram of an exemplary alternative non-intrusive element connected to an exemplary digital network, according to some embodiments;

FIG. 6B is a block diagram of an exemplary differential buffer of an exemplary alternative non-intrusive element connected to an exemplary digital network, according to some embodiments;

FIGS. 7A-7C show an exemplary non-intrusive element connected to one or more wires carrying digital communication, according to some embodiments; and

FIG. 8 is an exemplary screenshot of a network analyzer/monitoring system, according to some embodiments.

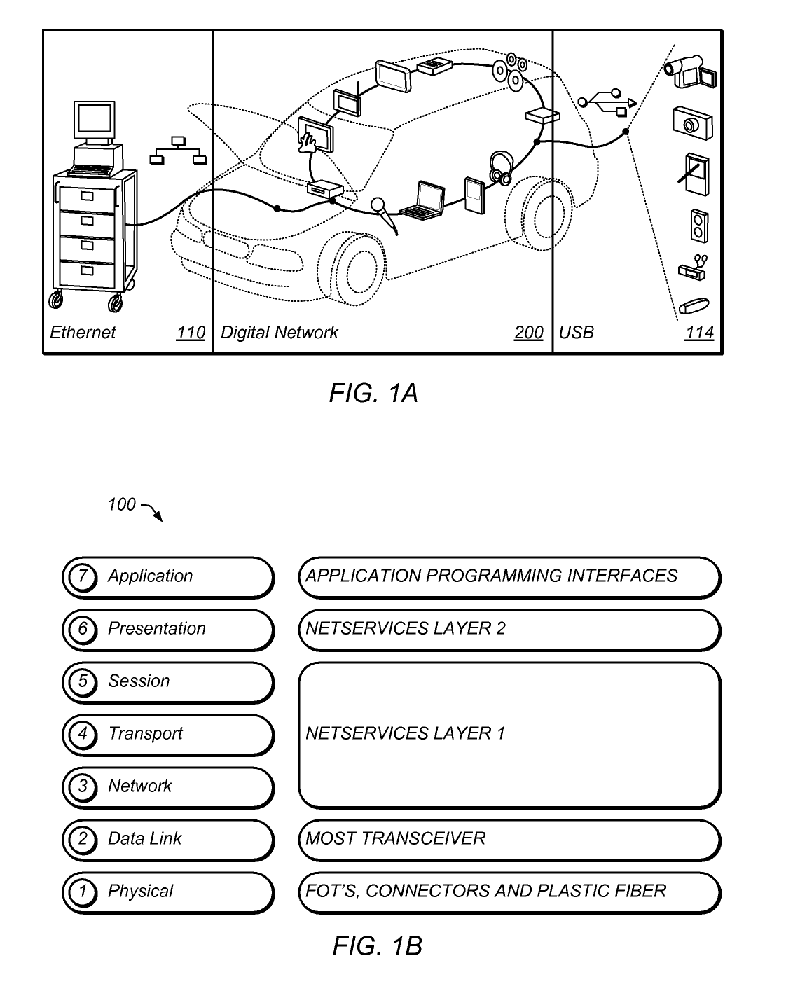

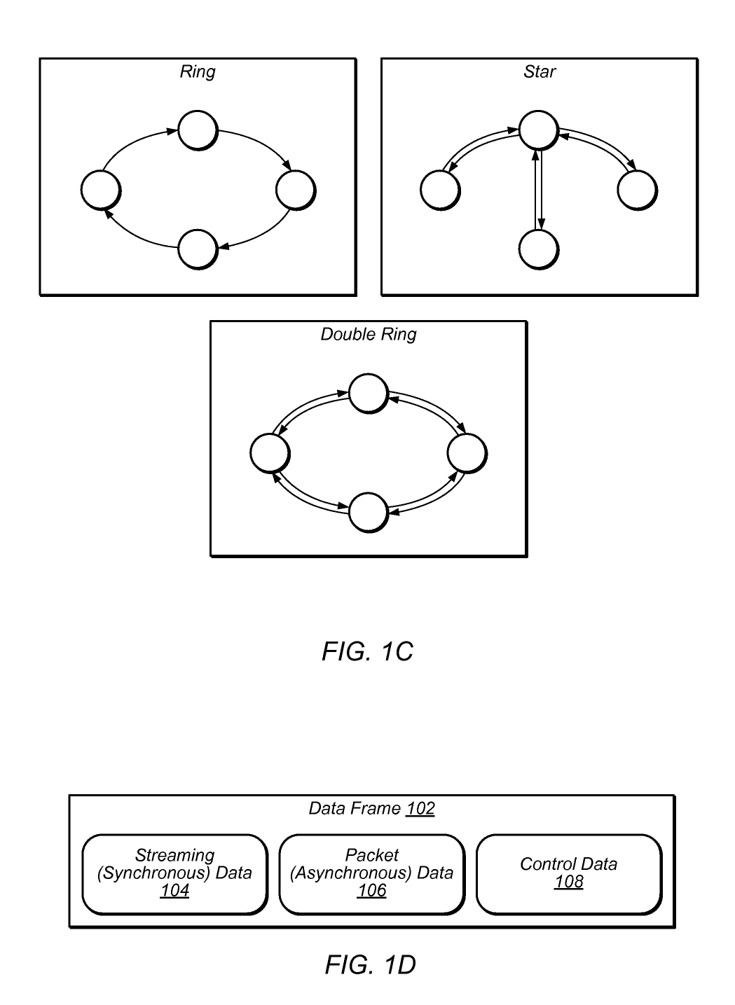

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE INVENTION

### Incorporation by Reference:

The following references are hereby incorporated by reference in their entirety as though fully and completely set forth herein:

MOST Specification rev. 3.0 of May 2008.

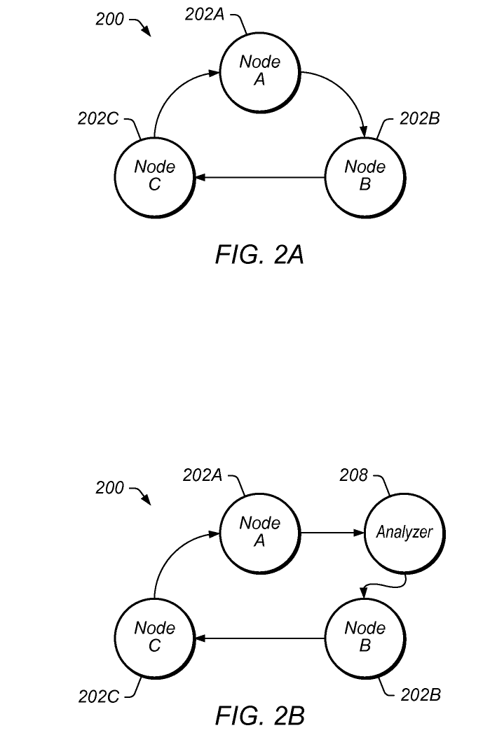

### FIG. 3A—Block Diagram of an Exemplary Two Device Digital Network

FIG. 3A is a block diagram of an exemplary two device digital network, according to some embodiments. The diagram shows a digital network where first network device 304A may be communicating with a second network device 304B using a physical medium carrying digital communication. The digital network may be a MOST network, a D2B network, variants of the CAN network, J1850, J1939, APC, AUTOLAN, VAN, PALMNET, IDB-1394, OSEK/VDX, and/or SMARTWIREX/DB2, as well as industrial and/or deterministic digital networks such as CAN, DEVICENET, PROFIBUS; FOUNDATION FIELDBUS; or any other digital network used in automobiles and/or industry. Network devices (e.g., nodes) may be connected to the digital network using a ring topology, star configurations, and double rings, multi-drop, beside others.

In some embodiments, digital communication between two or more network devices (i.e., sending and receiving of a plurality of network packets according to a digital communication protocol) may be sent over one or more fiber optic cables. In some embodiments, the digital communication may be sent over any of a number of wireless communication standards. In some embodiments, the digital communication may be sent over one or more physical wires 320A/B, including differential lines such as unshielded twisted pair (UTP) wires, and/or other types of physical wires /cables operable to carry electrical signals. For example, the one or more physical wires may comprise a foiled twisted pair (FTP), shielded twisted pair (STP or STP-A), as well as variants of UTP such as screened unshielded twisted pair (S/UTP, sometimes referred to as FTP), screened shielded twisted pair (S/STP or S/FTP), category 5 cables (Cat-5), T568A and/or T568B wiring, and other standards/types of wiring, among others.

### FIG. 3B—Block Diagram of a Non-Intrusive Probe Coupled to a Digital Network

FIG. 3B is a block diagram of an exemplary non-intrusive probe coupled to an exemplary digital network, according to some embodiments.

In some embodiments, a non-intrusive probe 340 may be coupled to a digital network 200 using a non-intrusive element 302. The non-intrusive element 302 may be a transformer that may use a ferrite bead, or any other type of element that is operable to induce electrical signals onto the non-intrusive element 302. Thus the non-intrusive element 302 may be able to “read” digital communication that is sent between a first network device 304A and a second network device 304B. The non-intrusive element 302 may be able to “read” the digital communication without creating another network device on the digital network. In other words, the coupling of the non-intrusive element 302 may not affect the digital network, which may not be aware of the non-intrusive probe 340 being on the digital network 200.

The non-intrusive probe 340 may be operable to send at least a portion of the digital communication captured by the non-intrusive element to a network analyzer (not shown). For example, the non-intrusive probe 340 may be operable to capture physical layer information of the digital communication. In other words, the non-intrusive probe 340 may be operable to capture data for the one or more of the OSI layer communication using the physical layer of the communication protocol that is used by the digital network.

The non-intrusive probe 340 may be operable to couple to various digital networks, including automobile networks, such as a MOST network, a D2B network, and some variants of the CAN network, as well as industrial/deterministic networks such as a CAN network, a DEVICENET network, a PROFIBUS network; a FOUNDATION FIELDBUS network; or any other digital network used in automobiles and/or industry. Use of the non-intrusive probe in other types of networks is contemplated.

In some embodiments, a processing unit 306 may perform some initial processing, signal conditioning, and/or buffering on the captured portion of the digital communication (i.e., sent via 312A/B) before transmitting the data 350 to a network analyzer. For example, the processing unit 306 may use a buffer in order to better match an output impedance of the non-intrusive element 302 with an input impedance of the network analyzer. The processing unit may also filter and/or amplify the captured portion of the digital communication before transmitting the data 350 to the network analyzer. In some embodiments, the processing unit may not be used.

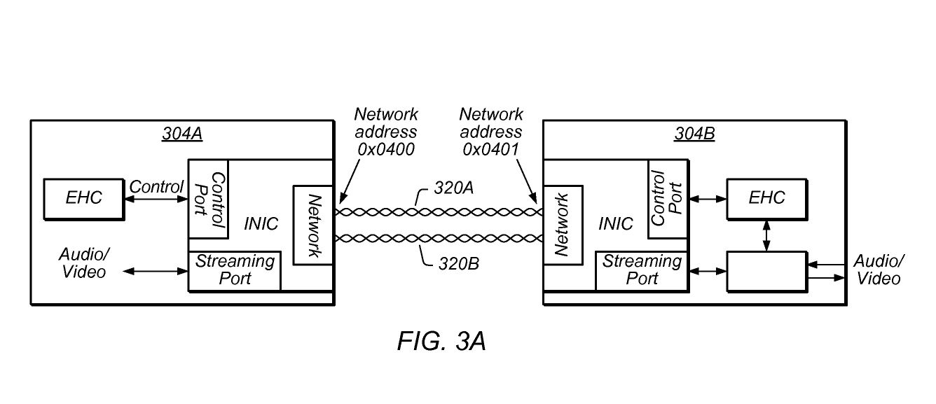

### FIG. 4—Exemplary Non-Intrusive Element

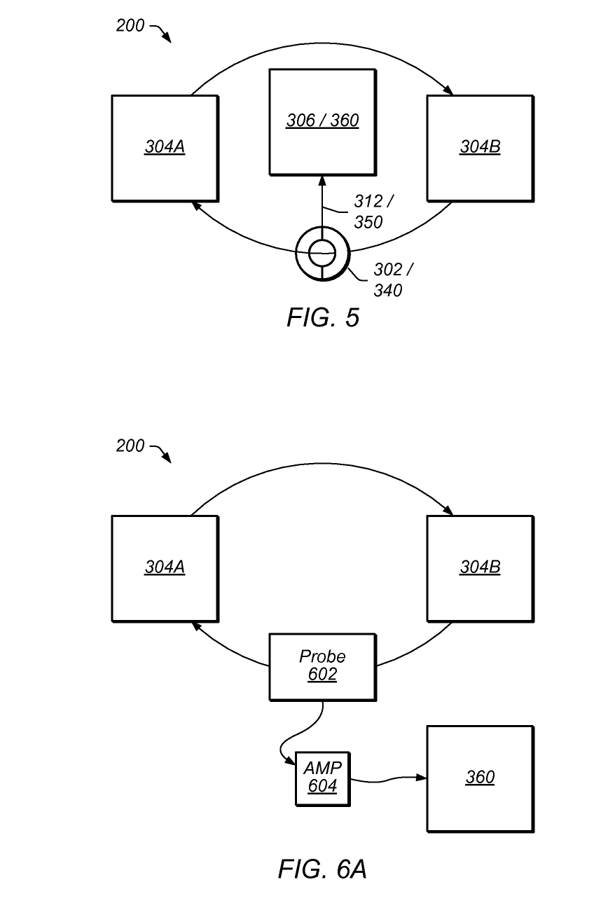

FIG. 4 shows an exemplary non-intrusive element, according to some embodiments. Alternative non-intrusive elements are discussed above with reference to FIGS. 6A/B.

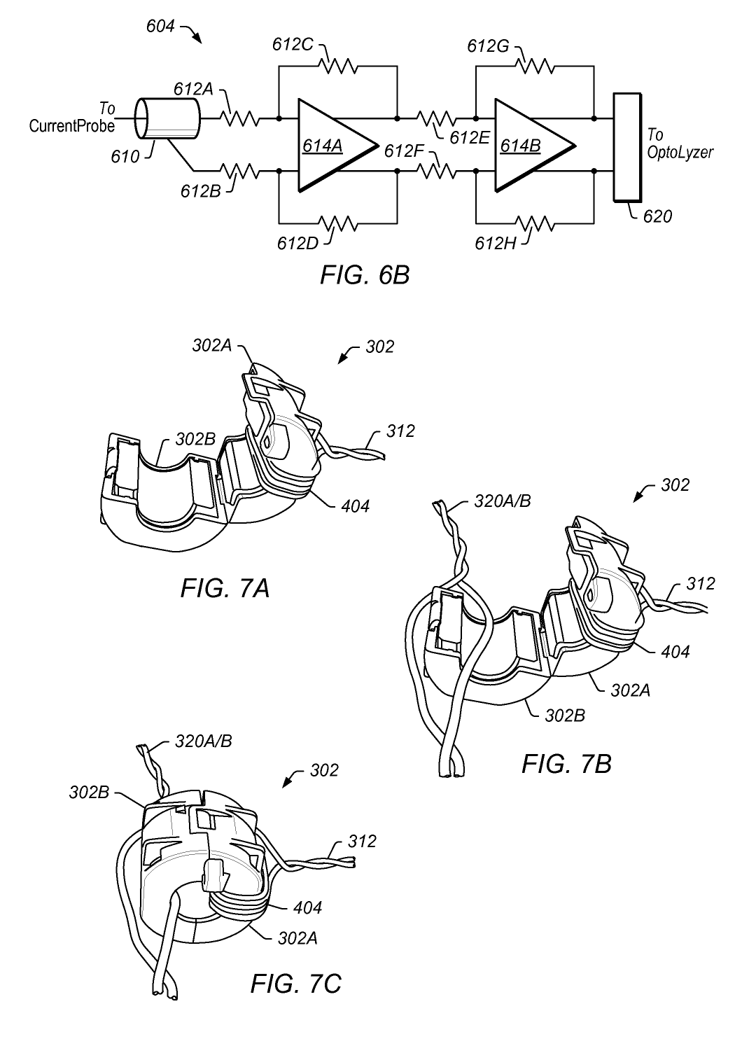

A non-intrusive element 302 such as a ferrite bead may be used to couple to one or more physical wires (i.e., communication lines) carrying digital communication between two or more network devices on a digital network. More detailed operation of installation of an exemplary non-intrusive element is described below with reference to FIGS. 7A-C. The non-intrusive element may substantially surround the one or more physical wires carrying digital communication, where the physical wires may include differential lines such as unshielded twisted pair (UTP) wires, but may also connect to other types of twisted pair cablings as well as other types of physical wires/cables operable to carry electrical signals. For example, the non-intrusive element (e.g., a ferrite bead) may be able to couple to wires/lines using a foiled twisted pair (FTP), shielded twisted pair (STP or STP-A), as well as variants of UTP such as screened unshielded twisted pair (S/UTP, sometimes referred to as FTP), screened shielded twisted pair (S/STP or S/FTP), category 5 cables (Cat-5), T568A and/or T568B wiring, and other standards/types of wiring, among others.

In some embodiments, the non-intrusive element may have one or more loops of wire 404 around it in order to facilitate transformer-like operation. Thus the non-intrusive element may operate to capture the digital communication transmitted in the communication lines 320 and send it using its own lines (e.g., wires) 300A-B to a network analyzer.

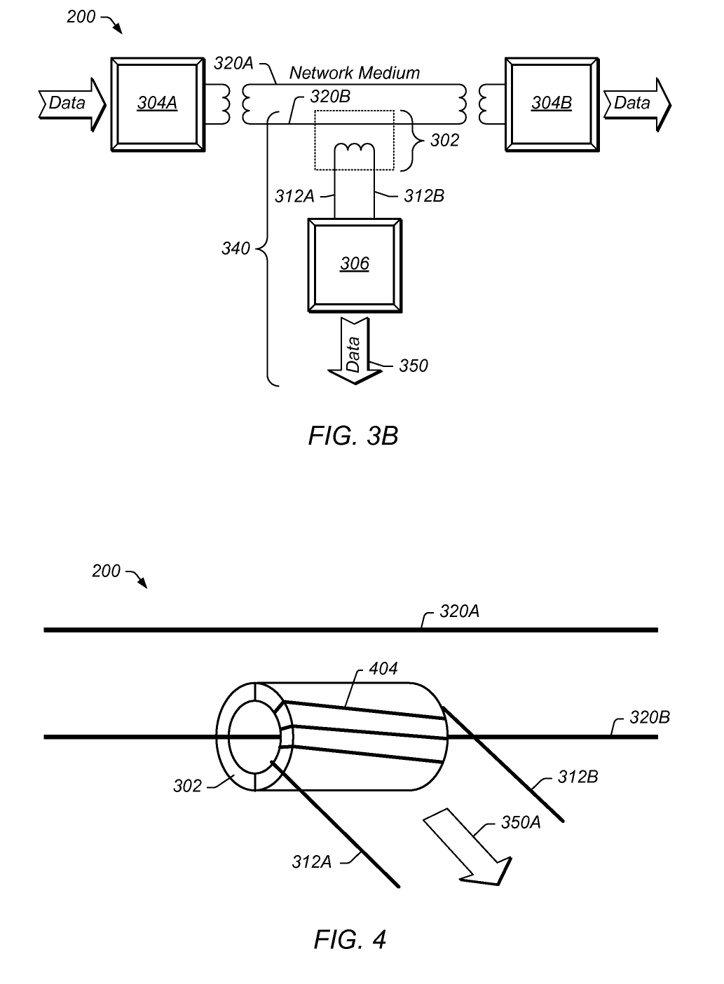

### FIG. 5—Exemplary Non-Intrusive Element

FIG. 5 illustrates an exemplary test set-up where a network analyzer 360 may be able to receive captured portion of digital communication data 350 from the non-intrusive probe 340 that uses the non-intrusive element 302. The network analyzer may be operable to perform initial analysis of the captured portion of digital communication data 350. The network analyzer then may send the analyzed portion of digital communication data 350 to a computer for display and/or further analysis. Alternatively, the network analyzer may display the analyzed portion of digital communication data 350 on an included and/or attached display (not shown). Alternatively the captured portion of digital communication data 350 may be sent directly to the computer from non-intrusive probe 340, thus bypassing the network analyzer 360.

In some embodiments, a processing unit 306 may be used in addition to the data analyzer 360 to perform initial processing, signal conditioning, and/or buffering on the captured portion of the digital communication (e.g., via elements 312A/B) before transmitting the data to a network analyzer. For example, the processing unit 306 may use a buffer in order to better match an output impedance of the non-intrusive element 302 with an input impedance of the network analyzer. The processing unit may also filter and/or amplify the captured portion of the digital communication before transmitting the data to the network analyzer.

### FIGS. 6A-B—Exemplary Alternative Non-Intrusive Element

FIGS. 6A-B illustrate another exemplary non-intrusive element, according to some embodiments.

In some embodiments, as shown in FIG. 6A, a current probe 602 may be combined with a differential buffer 604 to unobtrusively couple to a digital network. The current probe 602 may be operable to capture at least a portion of the digital communication between the two or more network devices. The differential buffer 604 may be operable to receive the captured portion of the digital communication from the current probe 602 and send the captured portion of the digital communication to a network analyzer 360.

FIG. 6B illustrates an exemplary differential buffer 604. In some embodiments, the differential buffer 604 may include an input element 610, which may receive the captured digital communication from the current probe 602, and an output element 620, which may output amplified digital communication to the network analyzer 360. The differential buffer 604 may be used in order to match an input section of the network analyzer 360. The differential buffer 604 may include one or more op-amps, such as AD 8139 differential ADC (analog to digital converter) drivers 614A/B, as well as a plurality of resistors 612A-H. It is noted that the differential buffer 604 is shown for explanation purposes only, and many other implementations and/or variations of the differential buffer 604 are contemplated.

### FIG. 7A-C—Exemplary Non-Intrusive Element

FIGS. 7A-C illustrate an exemplary non-intrusive element that may be connected to one or more wires, according to some embodiments.

FIG. 7A illustrates an exemplary non-intrusive element 302, such as a ferrite bead, that is open, i.e., before it is coupled to one or more lines/wires carrying digital communication. Other implementations of the non-intrusive element are contemplated, such as use of more than two portions, different location and/or number of wires in coil, different locking mechanism, among others. Furthermore, the non-intrusive element may use various different materials which may be used instead of, or in addition to, a ferrite bead. As shown, the non-intrusive element may have two or more portions 302A/B that may be open in order to couple substantially around a physical wire that is carrying digital communication. In some embodiments, the non-intrusive element 302 may also have one or more coils of wire 404 that help the non-intrusive element 302 to act as a transformer. In some embodiments, the non-intrusive element 302 may use a different method of inducing a voltage from the digital communication transmitted in the physical wires (see elements 320A/B).

FIG. 7B illustrates an exemplary non-intrusive element 302 that may be placed under one of the one or more lines/wires 320A/B carrying digital communication. As mentioned above, the non-intrusive element 302 may operate to couple to the digital network without introducing any delays/timing issues/new network devices. Furthermore, the non-intrusive element 302 may operate to couple to the digital network without physically damaging/altering any of the physical lines/wires 320A/B carrying the digital communication. As shown, two or more portions of the non-intrusive element 302A/B may be operable to close/clamp together substantially around the one of the one or more lines/wires 320A/B. In some embodiments three or more parts of the non-intrusive element 302 can be used. In some embodiments, other method(s) to place the non-intrusive element 302 around the of the one or more lines/wires 320A/B may be used, such as threading a non-intrusive element 302 around the one of the one or more lines/wires 320A/B. In some embodiments, the non-intrusive element 302 may be placed around all of the one or more lines/wires 320A/B.

FIG. 7C illustrates an exemplary non-intrusive element 302 that is coupled to the one of the one or more lines/wires 320A/B carrying digital communication. As shown, two or more portions 302A/B of the non-intrusive element may close (or clamp) substantially together around the one of the one or more lines/wires 320A/B. In some embodiments, the closing of the two or more portions 302A/B of the non-intrusive element, along with the one or more wire loops 404, may operate to create a transformer that is able to capture at least a portion of the digital communication transmitted on the one or more lines/wires carrying digital communication.

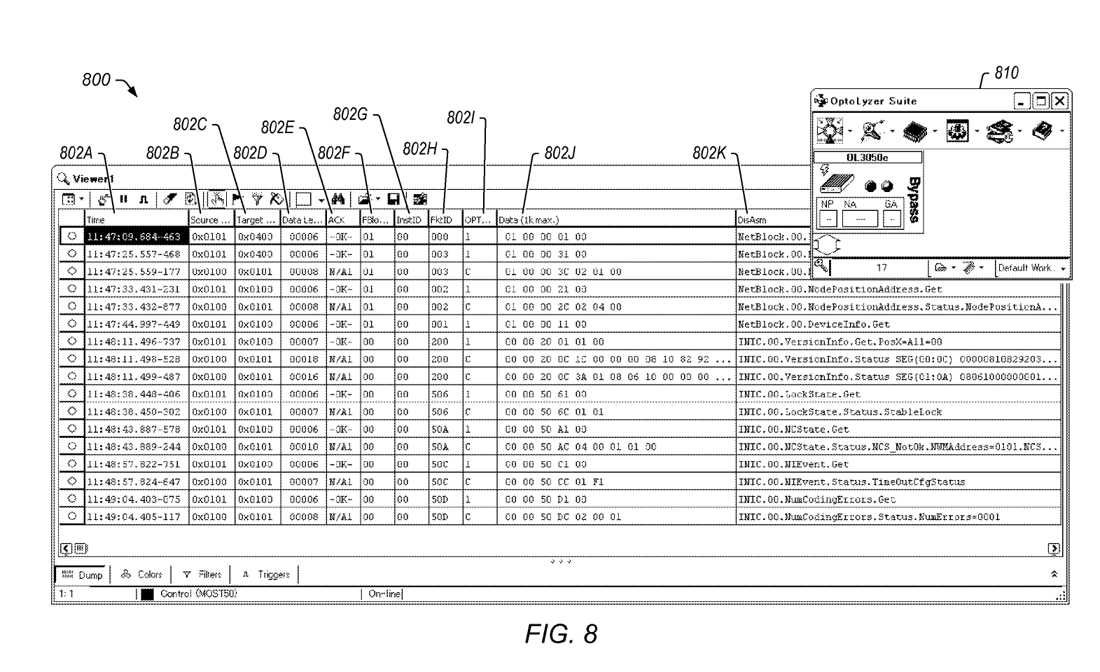

### FIG. 8—Exemplary Display of a Network Analyzer

FIG. 8 shows an exemplary screenshot of a network analyzer, according to some embodiments.

In some embodiments, the network analyzer may send one or more portions of the captured data (i.e., captured digital communication) to a computer for further analysis. In some embodiments, the network probe may send the one or more portions of the captured data to a computer for further analysis without using the external network analyzer; thus the computer may operate similarly to the external network analyzer. Alternatively, the network analyzer may have an own display that can shown the captured digital communication. Thus, the screenshot 800 may be that of a stand-alone network analyzer and/or the computer.

In some embodiments, the network analyzer (i.e., including the computer and/or the external network analyzer) can display raw captured data and perform some analysis. The display can show various parameters of the captured data, such as time of the data, source device, target device, data length, presence of acknowledgement of receipt of the data (ACK), type and/or number of function blocks, instruction ID, function ID, options, raw data, as well as disassembly of the data (such as higher OSI layer instructions) 802A-K. The network analyzer can also include other software 810 for monitoring and/or analyzing of the captured data.

Thus embodiments of the invention include a method to use a non-intrusive element to couple to a digital network and capture digital communication between two or more devices on the digital network. The non-intrusive element operates to connect to the digital network without introducing any delays/timing issues and/or without creating another network device on the digital network.

Although the embodiments above have been described in considerable detail, numerous variations and modifications will become apparent to those skilled in the art once the above disclosure is fully appreciated. It is intended that the following claims be interpreted to embrace all such variations and modifications.

We claim:

1 A method to monitor a digital network, the method comprising:
connecting to a digital network using a non-intrusive element;
monitoring digital communication on the digital network using the non-intrusive element;
capturing a portion of the digital communication using the non-intrusive element;
sending the captured portion of the digital communication to a network analyzer, wherein the network analyzer is operable to read and analyze the captured portion; and
analyzing the captured portion of the digital communication using the network analyzer.

2. The method of claim 1,
wherein the non-intrusive element comprises a transformer.

3. The method of claim 1,
wherein the digital network comprises one or more differential lines carrying the digital communication;
wherein the non-intrusive element comprises a separated ferrite, wherein the separated ferrite comprises two or more portions; and
wherein monitoring comprises placing the two or more portions of the separated ferrite around the one or more differential lines, wherein placing operates to substantially surround the one or more differential lines with the two or more portions of separated ferrite.

4. The method of claim 1,
wherein said capturing the portion of the digital communication operates to capture a plurality of communication packets; and
wherein one or more of the plurality of communication packets comprise fields for one or more of time, source device, target device, and data.

5. The method of claim 4, further comprising:
displaying the captured portion of the digital communication, wherein displaying operates to display the one or more of time, source device, target device, and data fields for the plurality of communication packets.

6. The method of claim 1,
wherein said using the non-intrusive element comprises said monitoring the digital communication without placing another node on a digital network carrying the digital communication.

7. The method of claim 1, wherein the digital network comprises:
a MOST network;
a D2B network;
a CAN network;
a DEVICENET network;
a PROFIBUS network;
a FIELDBUS network; or
any other digital network used in automobiles.

8. The method of claim 1,
wherein the digital network uses one or more of a ring, star, or double-ring topology; and
wherein the digital network comprises two or more network devices, wherein said connecting using the non-intrusive element does not add an additional network device to the digital network.

9. The method of claim 1,
wherein said connecting, said monitoring, and said capturing operates to said analyze the digital network without interruption in the digital communication.

10. The method of claim 9,
wherein the interruption in the digital communication operates to disturb the digital communication on the one or more differential lines.

11. A non-intrusive method to monitor a digital network, the method comprising:
using a non-intrusive element, connecting to one or more differential lines carrying digital communication on an automobile digital network, wherein connecting does not physically alter the one or more differential lines;
monitoring the digital communication using the non-intrusive element;
capturing a portion of the digital communication using the non-intrusive element;
sending the captured portion of the digital communication to a network analyzer operable to analyze the captured portion; and
analyzing the captured portion of the digital communication using the network analyzer.

12. A method to monitor a digital network, the method comprising:
using a non-intrusive element, connecting to one or more differential lines carrying digital communication on a Media Oriented Systems Transport (MOST) digital network between a first MOST device and a second MOST device, wherein connecting does not add a third MOST device;
capturing a portion of the digital communication using the non-intrusive element; and
sending the captured portion of the digital communication to a network device operable to read the captured portion.
